(19) United States
(12) Patent Application Publication
(10) Pub. No.: US 2008/0309978 A1
(43) Pub. Date: Dec. 18, 2008

(54) Multi-function device

(75) Inventor: Takaaki Shirai, Nagoya-shi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/896,169

(22) Filed: Aug. 30, 2007

(30) Foreign Application Priority Data
Aug. 31, 2006 (JP) 2006-236110

(51) Int. Cl. G06F 15/00

(52) U.S. Cl. 358/1.16

(57) ABSTRACT

A multi-function device capable of performing at least a first function and a second function, the multi-function device includes a function performing unit that operates to perform the first function and the second function, a memory that stores use condition data including a setting of use condition for each of the first function and the second function for each user, an input unit that inputs a setting of the use condition for the operation of the function performing unit for each user, and a controller that is operable to reflect the setting of the use condition inputted by the input unit to the setting of the use condition for each of the first function and the second function included in the use condition data.

### CROSS-REFERENCE TO RELATED APPLICATIONS

This application claims priority from Japanese Patent Application No. 2006-236110 filed on Aug. 31, 2007, the entire subject matter of which is incorporated herein by reference.

### TECHNICAL FIELD

Aspects of the present invention relate to a multi-function device.

### BACKGROUND

There has been provided a multi-function device in which functions of a printer, a copier, a scanner and a facsimile are integrated in one apparatus. Such multi-function device can be shared for various purposes among many users in an office and so on. However, it may not be preferable to permit all the users to use the multi-function device unconditionally. Therefore, it is proposed to impose use restriction on a part of various functions of the multi-function device for each user.

For example, the use of the color print or color copy is prohibited for the user for whom it is supposedly not required to use color print or color copy on the business. In this manner, a frequency of performing the color print or color copy having a high running cost per sheet is reduced, and the total running cost is suppressed. From the viewpoint of providing adequate security, the use of the communication function such as facsimile may be permitted for only a part of users, but prohibited for the remaining users. Thus, even if one multi-function device is shared among plural users, security can be assured.

In this manner, when one multi-function device is shared among plural users, there are merits that the use of functions is restricted for each user. JP-A-2005-244488 discloses an example of such multi-function device. The multi-function device has a use condition table for judging whether the use of the multi-function device is permitted or prohibited for the user, when each user uses the multi-function device.

FIG. 14 is a view showing one example of use condition table for use in related multi-function device. The use condition table 100 includes, for each function, the setting items 102 in list form and the information 104 indicating the use condition of each setting item, as shown in FIG. 14.

According to the multi-function device, an user ID is read from a cardholder dangled from the neck of the user. The read user ID is collated with the use condition table 100 associated to permit or prohibit various kinds of function for each user and impose restriction on the use of functions. Therefore, the use condition for each user can be set minutely for each function to produce the service condition according to rights of each user.

Incidentally, when the detailed setting is made by subdividing the setting item for each function, items to be set are set by setting operation of the manager. Herein, the manager means the person who makes the setting operation for the use condition in the multi-function device. This manager mainly performs a new registration operation for newly setting and registering the use condition for the new user or changing the registered information, when the new users are increased.

### SUMMARY

Aspects of the invention provide a multi-function device in which the working load of the manager can be relieved.

### BRIEF DESCRIPTION OF THE DRAWINGS

FIG. 1 is an exemplary block diagram of a multi-function device according to a first aspect of the present invention;

FIG. 2 is an exemplary view showing setting items and template T storing the settings for the setting items;

FIG. 3A is an exemplary view showing a user memory and FIG. 3B is an exemplary view showing a group name memory;

FIG. 4 is a view for explaining a working procedure of a manager in registering a new user in the user memory;

FIG. 5 is a flowchart showing a function axis setting process according to the first aspect;

FIG. 6 is a flowchart showing a means axis setting process according to the first aspect;

FIG. 7 is a flowchart showing a new user registration process according to the first aspect;

FIG. 8 is a flowchart showing a grouping process according to the first aspect;

FIG. 9 is an exemplary block diagram showing a manager terminal in which use condition setting program is installed and the multi-function device connected to a manager terminal according to a second aspect;

FIG. 10 is a flowchart showing the means axis setting process according to the second aspect;

FIG. 11 is a flowchart showing a first variation example of the setting items;

FIG. 12 is a flowchart, which corresponds to FIG. 2, showing a second variation example of the setting items;

FIG. 13 is a flowchart showing a third variation example of the setting items; and

FIG. 14 is a view showing one example of the use condition table for use in a related multi-function device.

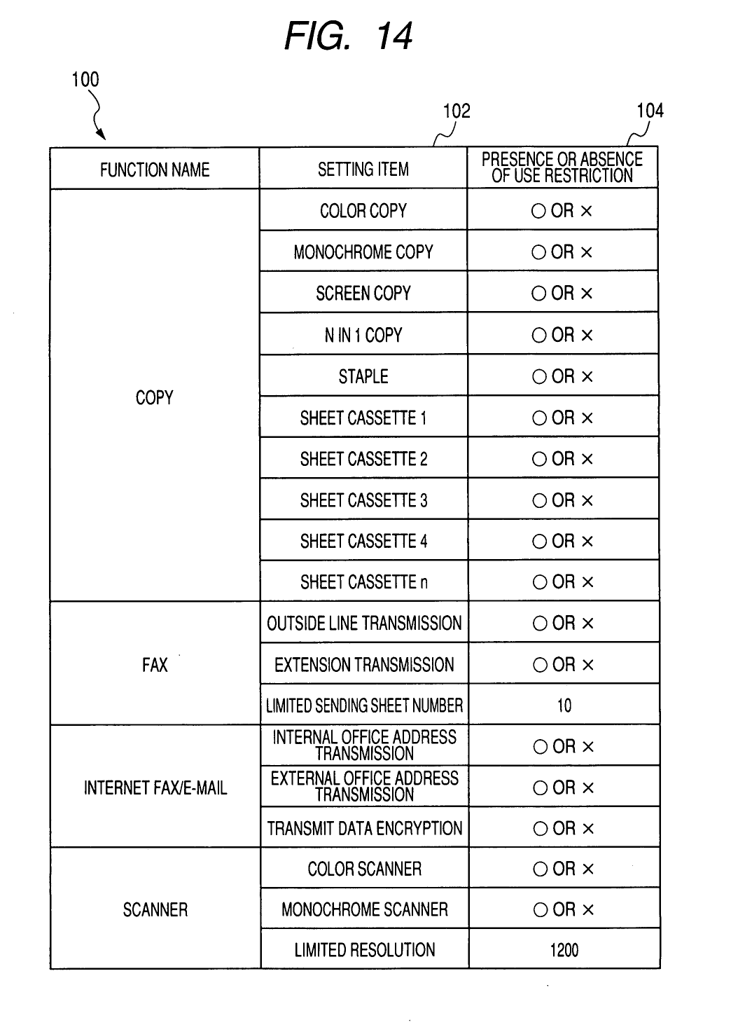

### DETAILED DESCRIPTION

### <General Overview>

According to an aspect of the invention, there is provided a multi-function device capable of performing at least a first function and a second function, the multi-function device including: a function performing unit that operates to perform the first function and the second function; a memory that stores use condition data including a setting of use condition for each of the first function and the second function for each user; an input unit that inputs a setting of the use condition for the operation of the function performing unit for each user; and a controller that is operable to reflect the setting of the use condition inputted by the input unit to the setting of the use condition for each of the first function and the second function included in the use condition data.

For example, the first function corresponds to at least one of a copy function, a printer function, a scanner function and the facsimile function. The second function corresponds to at least one of the copy function, the printer function, the scanner function and the facsimile function and is different from the first function. At least one of a reading unit, a printing unit and a connection unit corresponds to the function performing unit.

According to another aspect of the invention, there is provided a computer usable medium having computer readable instructions stored thereon, which, when executed by a computer for controlling a multi-function device capable of performing at least a first function and a second function, are configured to perform predetermined operations including: operating a function performing unit to perform the first function and the second function; storing in a memory use condition data including a setting of use condition for each of the first function and the second function for each user; inputting by an input unit the setting of the use condition for the operation of the function performing unit for each user; and reflecting the setting of the use condition inputted by the input unit to the setting of the use condition for each of the first function and the second function included in the use condition data.

According to still another aspect of the invention, there is provided a method for controlling a multi-function device capable of performing at least a first function and a second function, the method including: operating a function performing unit to perform the first function and the second function; storing in a memory use condition data including a setting of use condition for each of the first function and the second function for each user; inputting by an input unit the setting of the use condition for the operation of the function performing unit for each user; and reflecting the setting of the use condition inputted by the input unit to the setting of the use condition for each of the first function and the second function included in the use condition data.

### <Illustrative Aspects>

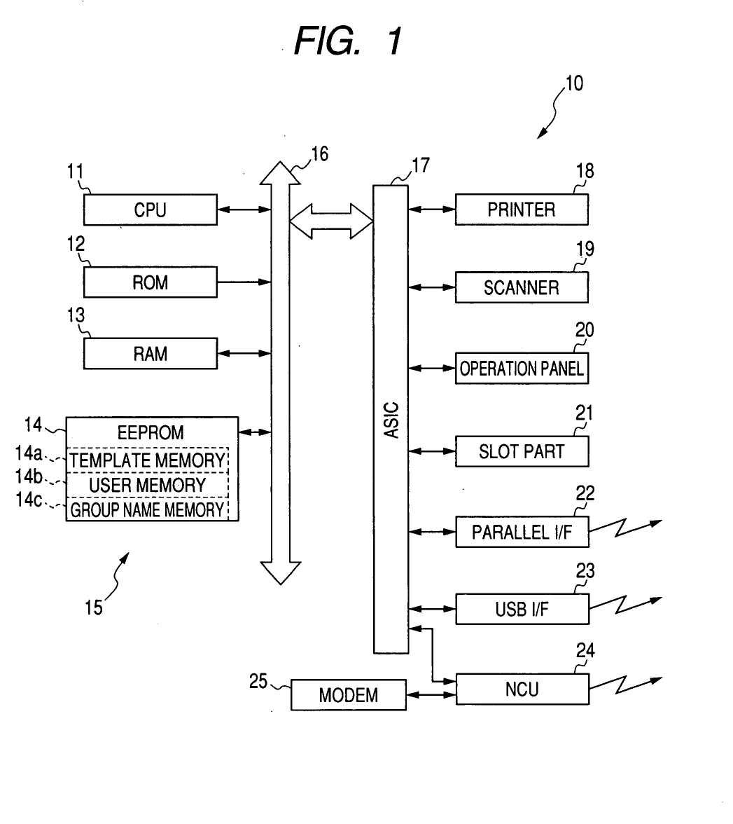

Illustrative aspects of the present invention will be described below with reference to the accompanying drawings. FIG. 1 is an exemplary block diagram of a multi-function device 10 according to a first aspect of the present invention. The multi-function device 10 includes a microcomputer 15 mainly composed of a CPU 11, a ROM 12, a RAM 13 and an EEPROM 14, an application specific integrated circuit (ASIC) 17 connected via a bus 16 to the microcomputer 15, a printer 18, a scanner 19, an operation panel 20, a slot portion 21, a parallel I/F 22, a USB I/F 23, a network control unit (NCU) 24, and a modem 25. This multi-function device 10 has a printer function, a scanner function, a copy function and a facsimile function. Incidentally, it is unnecessary that all the above functions are provided for the multi-function device 10. It is sufficient that at least two or more functions are provided. In the first aspect, the printer function, the scanner function, and the copy function correspond to either the first function or the second function in the claims.

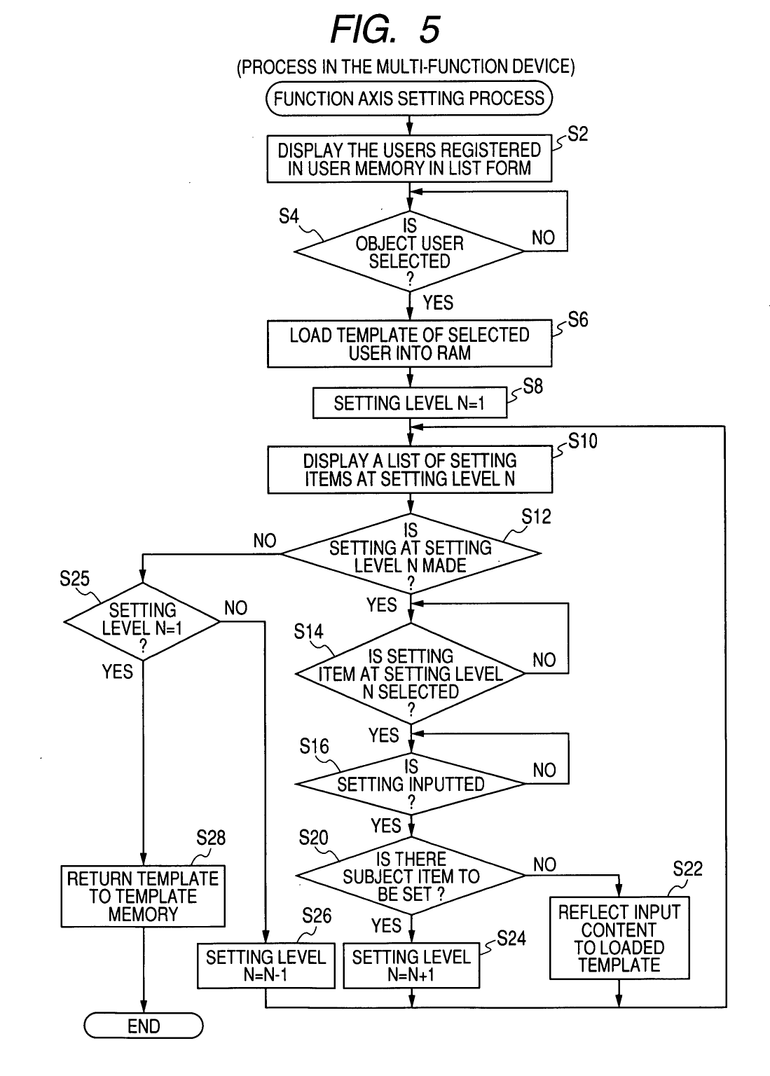

The CPU 11 is a central processing unit that controls the multi-function device 10 and executes various programs such as the programs for performing the processes as shown in the flowcharts of FIGS. 5 to 8. The CPU 11 may function as a controller of the multi-function device 10.

The ROM 12 is a non-volatile memory for storing various kinds of control programs executed by the CPU 11 and the fixed value data. The programs for performing the processes as shown in the flowcharts of FIGS. 5 to 8 (described later) are stored in this ROM 12. The RAM 13 temporarily stores the data or program required for various kinds of processes performed by the CPU 11.

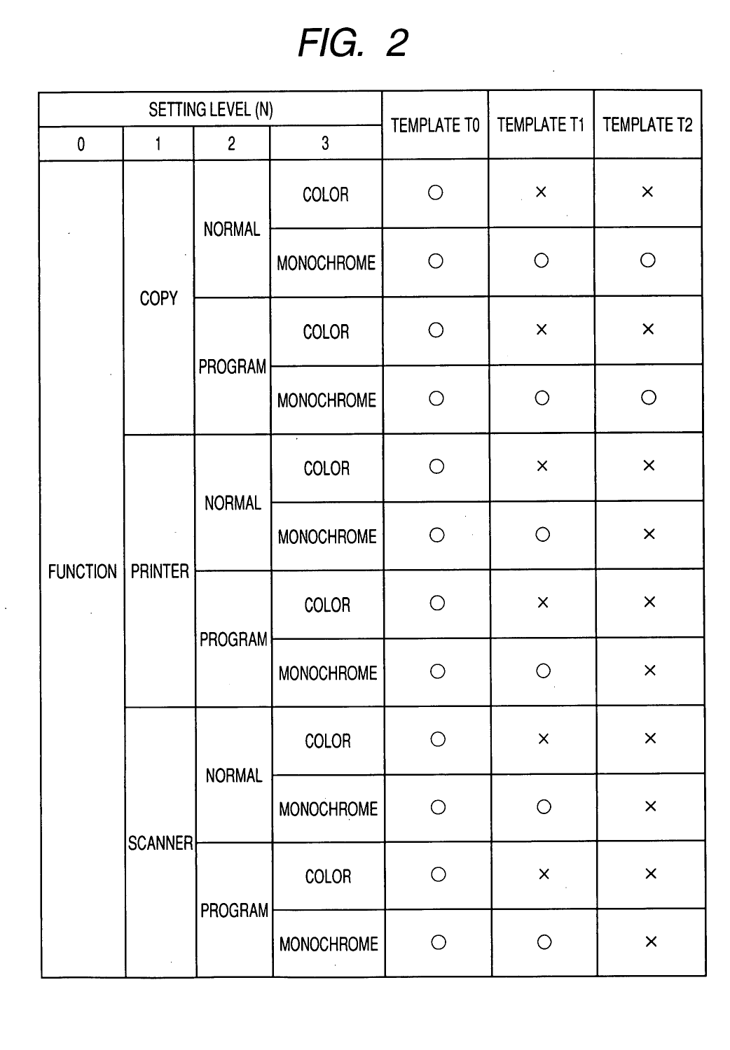

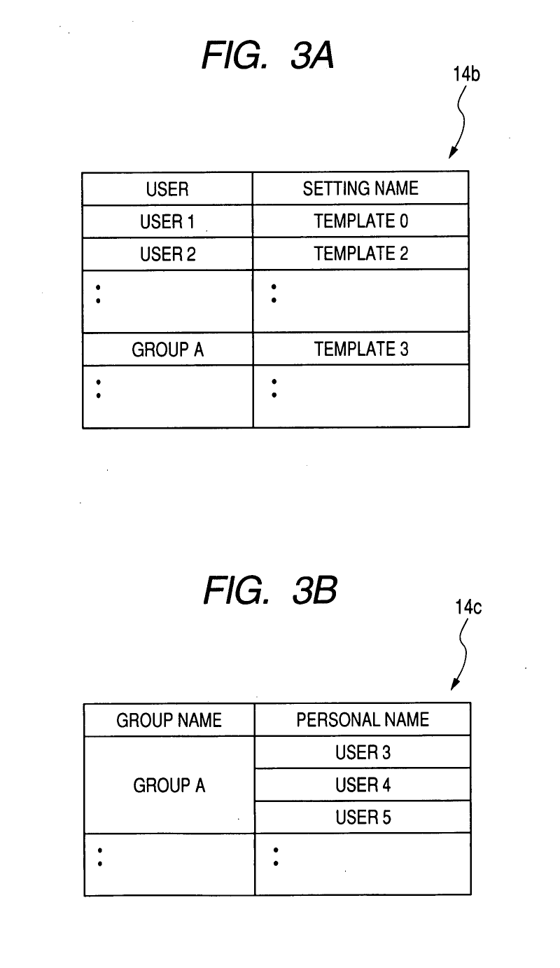

The EEPROM 14 is a rewritable non-volatile memory, including a template memory 14a for registering (storing) the template T (see FIG. 2), a user memory 14b, and a group name memory 14c. The template T registered in the template memory 14a will be described later with reference to FIG. 2. The user memory 14b and the group name memory 14c will be described later with reference to FIG. 3.

The ASIC 17 controls the operation of the printer 18, the scanner 19, the operation panel 20, the slot part 21, the parallel I/F 22, the USB I/F 23 and the NCU 24 in accordance with an instruction from the CPU 11.

The printer 18 prints the image on a recording sheet based on image data read by the scanner 19, data inputted via an LAN (not shown) from an external apparatus, or facsimile data received via the communication line. The printer 18 operates to perform the facsimile function (during reception), the copy function and the printer function. In this aspect, the printer 18 is a so-called laser printer of applying a laser beam onto a cylindrical photosensitive drum to make exposure, depositing the toner, and transferring the image onto the recording sheet. However, various printing methods such as an ink jet method and a thermal transfer method may be adopted.

The scanner 19 reads the image by emitting a light from a light source to apply the light onto the original, guiding the reflected light from the original via the lens to a photoelectric conversion element to output an electrical signal according to the intensity of reflected light. This scanner operates in performing the facsimile function (during transmission), the copy function and the scanner function.

The operation panel 20 is composed of various operation buttons and a liquid crystal display. The user and the manager can input a desired command from the operation panel 20. When the desired command is inputted into the multi-function device 10, the operation of the multi-function device 10 is controlled by the microcomputer 15 based on the inputted information. Also, in addition to the command inputted from the operation panel 20, the multi-function device 10 may be configured in the system to operate based on the command sent via a printer driver or scanner driver from the computer connected to the multi-function device.

The slot part 21 includes a plurality of card slots capable of loading various kinds of small memory card as recording medium. The slot part 21 operates to perform the scanner function. When a memory card is loaded into a card slot in the slot part 21, the image data is read from the loaded memory card. The image data read by the scanner 3 is written into the memory card in the slot part 21. This slot part 21 operates to perform the scanner function.

The parallel I/F 22 is the interface for connecting the multi-function device 1 with an external apparatus via a parallel cable. The USB I/F 23 is the interface for making the USB connection with an external apparatus to allow the communication between the multi-function device 10 and the external apparatus. The parallel I/F and the USB I/F operate to perform the printer function and the scanner function.

The ASIC 17 is connected to the NCU 24 and the modem 25 for implementing the facsimile function.

FIG. 2 is an exemplary view showing the setting item and the template T storing the setting for the setting item provided in the multi-function device 1 of the first aspect.

In the multi-function device 1 of the first aspect, the setting items regarding the use condition are provided for each of the copy function, the printer function and the scanner function. The setting items for each function have a hierarchical structure according to the setting level (N), in which as the setting level (N) is lower (the value of N is greater), the content of setting item is minuter.

The setting item belonging to the setting level (1) specifies whether the use of each function is permitted or prohibited. In the first aspect, either the “use permission” or “use prohibition” can be set for the setting item “copy” at the setting level (1).

The setting item belonging to the setting level (2) makes the minuter setting than the setting level (1). The setting item “normal” of the copy function means the copy of printing the image for original of one page on the recording sheet of one page. The setting item “program” of the copy function means the copy of printing the image for originals of plural pages on the recording sheet of one page with special processing such as Nin1 print or scale-up/scale-down. For each setting item, either the “use permission” or “use prohibition” can be set.

The setting item “normal” of the printer function means printing the image of one page in a print object file on the recording sheet of one page. The setting item “program” of the printer function means printing the image for plural pages in the print object file on the recording sheet of one page with special processing such as Nin1 print or scale-up/scale-down.

The setting item “normal” of the scanner function means sending the data read by the scanner 3 to a personal computer connected via the parallel I/F 22 or USB I/F 23. The setting item “program” of the scanner function means writing the data read by the scanner 3 in a memory card loaded into the slot of the slot part 21.

The setting item belonging to the setting level (3) makes the minutest setting. The “color” of the copy function means the color copy. The “monochrome” of the copy function means the monochrome copy. For example, if the “use prohibition” is set for the setting item “color”, and the “use permission” is set for the “monochrome”, the color printing operation is prohibited, while the monochrome printing operation is permitted.

The template T stores the setting for each setting item at the lowest setting level (setting level (3) in this aspect), as shown in FIG. 2. In the first aspect, when the “use permission” is set for any setting item, “O” is stored in the corresponding element of the template T. In contrast, when the “use prohibition” is set for any setting item, “X” is stored in the corresponding element of the template T.

In the first aspect, when the “use prohibition” is set for the setting item at the setting level (N), “X” is stored in the corresponding element of the template T for all the setting items belonging to the lower level of the setting item (hereinafter referred to as a subject item). That is, for example, when the “use prohibition” is set for the setting item “copy” at the setting level (1), “X” is stored in all the elements corresponding to “color” and “monochrome” of the subject item “normal”, or all the elements corresponding to “color” and “monochrome” of the subject item “program.”

This template T is additionally registered serially by an operation of the manager, as will be described later. In the first aspect, the template T0 and the template T1 are stored in the template memory 14a at the factory shipment time. In this manner, a combination of templates expected to be frequently used are prestored in the template memory 14a, whereby the operation load of the manager is relieved, as will be described later in detail.

FIG. 3A is an exemplary view showing the user memory 14b. The user memory 14b is the memory storing the correspondence between the user and the template T for reference when the user uses the user memory. Herein, the user means the individual, or a congregation or group of individuals, for whom the use of the multi-function device 10 is approved by the manager, in which the personal name (e.g., user ID) for identifying the individual or the group name for the congregation of individuals is registered in the user memory 14b.

FIG. 3B is an exemplary view showing the group name memory 14c. The group name memory 14c is the memory storing the correspondence between the group name and the personal name belonging to the group.

When the user instructs to perform any of the copy function, the printer function and the scanner function, the multi-function device 1 prompts the user to input the personal name. When the user inputs the own personal name from the operation panel 20 or an external device or the like connected to the multi-function device 1, the multi-function device 1 reads the template T associated with the personal name of the user by referring to the user memory 14b or the group name memory 14c. It is judged whether the use with the setting by the user is permitted or prohibited in accordance with the read template T. Only when the use is permitted, an operation instructed by the user is performed. For example, when the user for whom the “use prohibition,” is set for the color copy in the corresponding template T instructs the color copy, the color copy is not performed. Thus, the use is permitted or prohibited in accordance with the template T. Therefore, the manager only needs to once set the template T, and then the use by each user is permitted under the condition according to the template T.

Specific means for acquiring the personal name is not limited to means for prompting the user to input the personal name from the operation panel 20 or the external apparatus. For example, various other means, including means for dictating the personal name in a non-contact manner from the memory card carried by the user, may be employed.

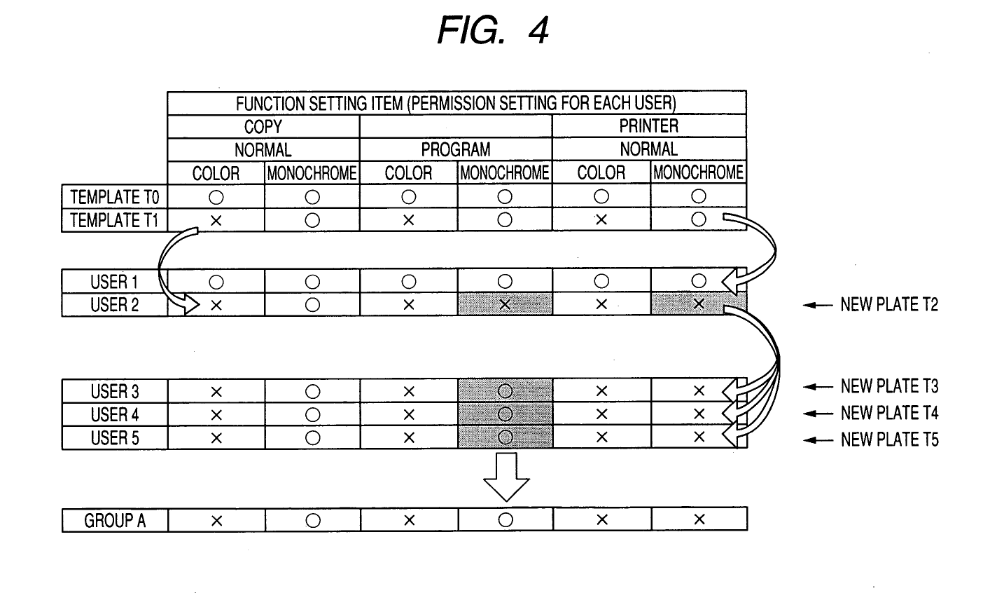

FIG. 4 is a view for explaining a working procedure of the manager when registering the new user in the user memory 14b (see FIG. 3A) in the multi-function device 1 according to the first aspect.

As an example, description has been made where the user 1 for whom all the settings should be permitted is registered as the new user. The template T0 for which “O” is stored for all the settings is registered beforehand in the template memory 14a (see FIG. 1), as described above. Hence, the manager can set all the setting items for the user 1 only by associating the registered template T0 with this user 1. Thus, the setting operation can be easily performed.

When the new template other than the registered template T0 and the registered template T1 is associated, the new template T can be created based on preliminary stored template T. For example, the template T1 is copied, and the template T2 is created by changing a part of the template T1 in accordance with an operation of the manager (changed element is indicated in gray in FIG. 4), and the new template T2 is associated with the user 2. In this manner, the manager needs to input the setting for only the setting item required to change. Therefore, the setting operation can be easily performed.

The new template T2 newly created in the multi-function device 10 of the first aspect is registered in the template memory 14a, as will be described later in detail. Hence, for example, when the new user 3 is registered, the already registered new template T2 is read, and the new template T3 is created by changing a part of the template T2 in accordance with an operation of the manager, and associated with the user 3. That is, the same or similar settings as already made for certain user are possibly employed for other users. Accordingly, the setting operation of the manager is relieved by making the already registered new template T usable.

The users for whom the settings of all the setting items are the same are grouped in the multi-function device 10 of the first aspect, as will be described later in detail. For example, the users 3, 4 and 5 are gathered as group A, because the settings of all the setting items are the same, and the new templates T3, T4 and T5 corresponding to the group A are integrated and managed as one template T. In this manner, the settings can be evenly changed from all the group members. Accordingly, the setting operation of the manager can be relieved, and the use area of the template memory 14a saved.

FIG. 5 is a flowchart showing a function axis setting process performed in the multi-function device 10 according to the first aspect. This function axis setting process is performed when the template T already registered in the template memory 14a (see FIG. 1) is changed. For example, this function axis setting process is performed when the manager makes a change request for the template T from the operation panel 20.

At first, the users registered in the user memory (see FIG. 3A) are displayed in list form (i.e., a list of personal names or group names is displayed) (S2). The operation waits until the user for whom the template T is to be changed (hereinafter referred to as an object user) is selected from among the users displayed in list form by the manager (S4). When the manager selects the object user on the operation panel 20 (S4: Yes), the template T associated with the selected user is read from the template memory 14a, and loaded into the RAM 13 (S6).

Then, the variable N indicating the setting level (N) is set to 1 (S8). A list of setting items of the setting level (N) specified by the variable N in the template memory 14a (see FIG. 2) is displayed on the operation panel 20 (S10). For example, since the variable N is equal to 1 at first, the setting items “copy”, “printer” and “scanner” at the setting level (1) are displayed on the operation panel 20 (see FIG. 2).

When the manager who sees this display selects to make the setting at the setting level (N) (S12: Yes), the operation waits until any setting item is selected from the setting items on display (S14). When the manager operates the operation panel 20 to select any setting item (S14: Yes), the operation waits until the setting as to whether the use of the selected setting item is permitted or prohibited is inputted (S16). For example, when the manager selects the setting item “copy” at the selection level (1), the operation waits until the manager inputs either the “use permission” or “use prohibition” for the setting item “copy.”

Next, it is judged whether or not there is any subject item to be set (S20). For example, when the manager inputs the “use permission” for the “copy”, there are subject items “normal” and “program” to be still set (S20: Yes). Thus, “1” is added to the variable N (S24), and the operation returns to the processing of S10.

In contrast, when the manager inputs the “use prohibition” for the “copy”, it is judged that there is no more subject item to be set (S20: No), because the “use prohibition” is uniformly set to the subject items “normal” and “program” in the multi-function device of the first aspect. The input content is reflected to the template T loaded into the RAM 13 (S22), and the operation returns to the processing of S10. For example, when the “use prohibition” is inputted for the selection item “copy”, “X” is stored in all the elements regarding the “copy” in the template T.

In contrast, when the manager does not select to make the setting at the setting level (N) (S12: No), it is judged whether or not the variable N is equal to 1 (S25). When the variable N is not equal to 1 (S25: No), the variable N is decremented by “1”, and the operation returns to the processing of S10.

When the variable N becomes equal to 1 while the process is repeated (S25: Yes), the template T loaded into the RAM 13 is returned to the template memory 14a (S28), and the operation is ended.

According to this function axis setting process, the manager firstly starts the setting operation from the setting level 1. That is, the manager can select a function desired to change the setting, and set the subdivided setting items for the function in order of the setting level (N).

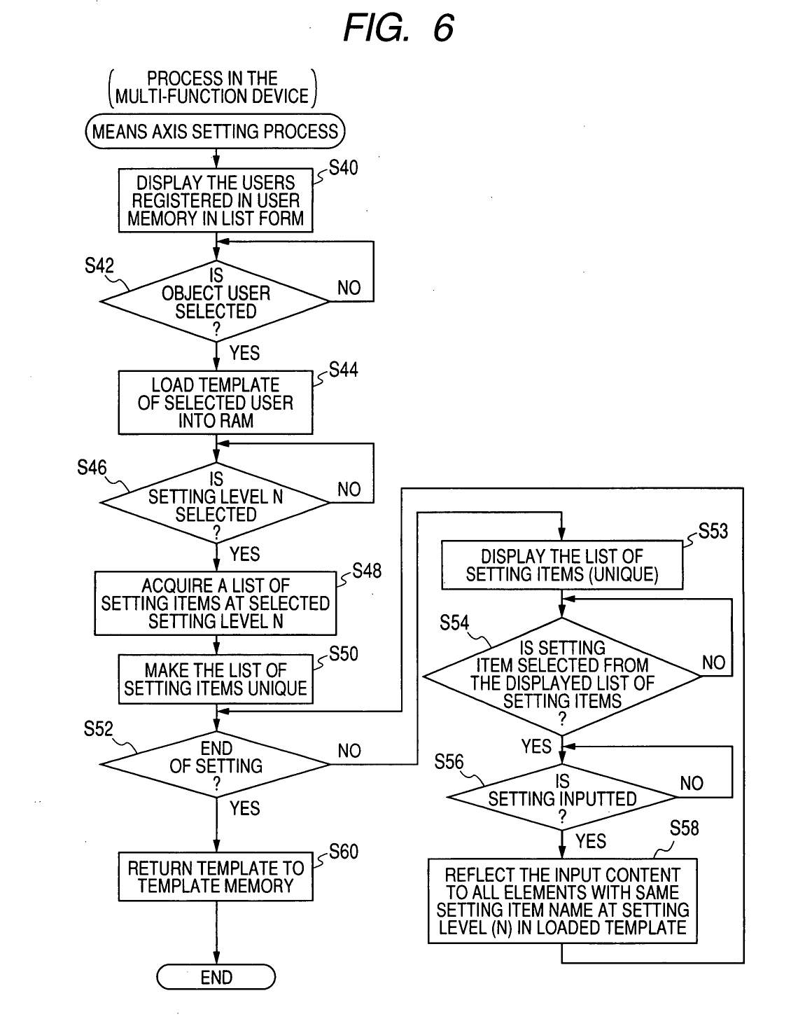

Referring to FIG. 6, the means axis setting process performed in the multi-function device 10 will be described below. FIG. 6 is a flowchart showing the means axis setting process. The means axis setting process is performed when the template T already registered in the template memory 14a is changed. For example, the means axis setting process is performed when the manager makes a change request for the template T from the operation panel 20, like the function axis setting process (see FIG. 5) as described above.

Though the function axis setting process (see FIG. 5) makes the setting for the subject item of the function for each function, the means axis setting process (see FIG. 6) makes the setting at each setting level (N). The means axis setting process is different from the function axis setting process in this point. The manager makes an input operation from the operation panel 20 to select between the function axis setting process (see FIG. 5) and the means axis setting process (see FIG. 6).

The means axis setting process firstly displays the users registered in the user memory (see FIG. 3A) in list form on the operation panel 20 (S40), as shown in FIG. 6. The operation waits until the object user is selected from among the users displayed in list form by the manager (S42). When the manager selects the object user on the operation panel 20 is (S42: Yes), the template T associated with the selected user is read from the template memory 14a (see FIG. 1), and loaded into the RAM 13 (S44).

The operation waits until the setting level (N) is selected (S46). When the setting level (N) is selected by the input of the manager from the operation panel 20 (S46: Yes), a list of setting items at the selected setting level (N) is acquired (S48). For example, when the setting level (3) is selected, the “color”, “monochrome”, “color”, “monochrome”, . . . are acquired as the list of setting items at the setting level (3) (see FIG. 2).

The acquired list of setting items is made unique to acquire the list of setting items (unique) (S50). Herein, the “making unique” means collectively describing the setting items with the same name at the setting level (3). For example, the list of setting items at the setting level (3) is “color”, “monochrome”, “color”, “monochrome”, . . . , the setting items with the same name are collected, so that the list of setting items (unique) includes one “color” and one “monochrome.”

Then, it is judged whether or not the setting end is selected by the manager (S52). When the setting end is not selected (S52: No), the list of setting items (unique) is displayed on the operation panel 20 (S53). The operation waits until any setting item is selected from the displayed list of setting items (unique) (S54). For example, when the setting level 3 is firstly selected by the manager, the “color” and “monochrome” are displayed as the unique list of setting items at the setting level 3. The operation waits until any of the “color” and “monochrome” is selected.

When any setting item is selected by the input of the manager from the operation panel 20 (S54: Yes), the operation waits until the setting is inputted into the setting item (S56). For example, when the setting item “color” is selected, the operation waits until any of the “use permission” and “use prohibition” is inputted for the setting item “color.”

When the setting is inputted from the operation panel 20 by the manager (S56: Yes), the inputted setting is reflected to the template T loaded into the RAM 13 (S58). At this time, the inputted setting is reflected to all the functions having the setting items with the same name at the selected setting level (N). For example, when the “use prohibition” is inputted for the setting item “color” at the setting level (3), the input is reflected to all the functions (copy, printer, scanner) having “color” in the subject item, and “X” is stored in all the elements corresponding to the setting item “color” in the template T.

For example, when the “use prohibition” is inputted for the setting item “program” at the setting level (2), the input is reflected to all the functions having “program” in the subject item, and “X” is stored in all the elements corresponding to the subject items (“color” or “monochrome”) of “program” in the template T.

When the setting end is selected by the manager (S52: Yes) while the process is repeated in this manner, the template loaded into the RAM 13 is returned to the template memory 14a and the process is ended (S60).

According to the means axis setting process, the setting inputted from the operation panel 20 is reflected to the settings for all the functions having the subject item with the same name. That is, one setting inputted from the operation panel 20 by the manager is reflected to the settings regarding the use conditions for plural functions. Accordingly, the working load of the manager can be relieved as compared with the case where the setting is inputted for each function.

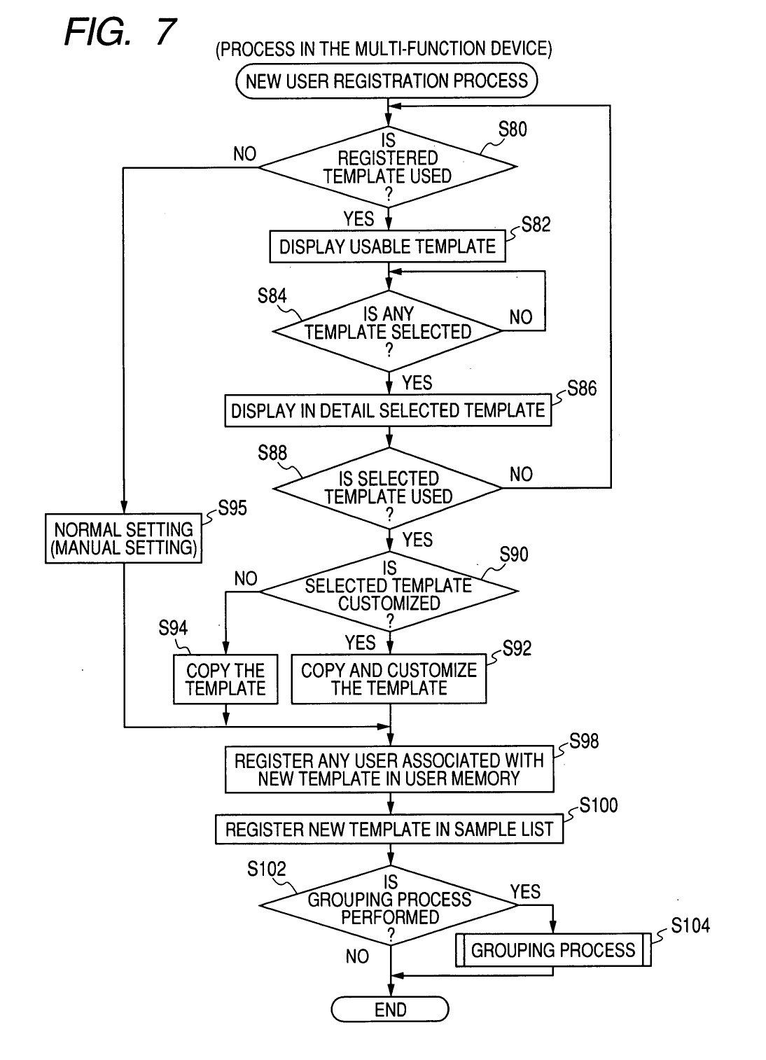

Referring to FIG. 7, a new user registration process performed in the multi-function device 10 will be described below. FIG. 7 is a flowchart showing the new user registration process. The new user registration process is performed when the manager inputs the new user name (new personal name) from the operation panel 20. The manager inputs whether or not to use the template T already registered in the template 14a at the same time when inputting the new user name.

At first it is judged whether or not the use of the registered template T is selected by the manager (S80). When the use of the registered template T is not selected (S80: No), a normal setting in which the manager manually inputs all the settings to be stored in the template T is performed and the new template candidate is created (S95).

In contrast, when the registered template T is used (S80: Yes), the template T stored in the template memory 14a is displayed as the usable template T (sample data) on the operation panel 20 (S82). In the first aspect, considering the case where the area of the display screen on the operation panel 20 is not so large, the simple information of the template T (template name, creation date of template T, user name associated with template, etc.) is only displayed.

Then, the operation waits until any template T is selected by the manager (S84). When any template T is selected (S84: Yes), the detailed information of the selected template T is displayed on the operation panel 20 (S86). Herein, the detailed information is the information indicating the setting item and the setting stored for the setting item, as shown in FIG. 4, for example. Accordingly, the manager can know the details of the selected template T.

When the manager who sees the details decides not to use the template T (S88: No), the operation returns to S80 in order to repeat the process.

In contrast, when the manager who sees the details decides to use the template T (S88: Yes), the manager is inquired about whether or not the selected template T is customized (changed). When the user selects not to customize the template (S90: No), the selected template T is copied to create the new template candidate (S94). In contrast, when the user selects to customize the template (S90: Yes), the template T is copied, and the manager performs a change operation for the copy to create the new template candidate (S92). The manager may perform this change operation by displaying the detailed contents of the template T on the operation panel 20, as shown in FIG. 4, for example. Alternatively, the manager may perform the change operation by making the function axis setting process (see FIG. 5) or the means axis setting process (see FIG. 6).

The new template candidate created at the processing of any of S92, S94 and S95 is registered, associated with the user name (personal name) to be newly registered, in the user memory 14b (S98). And the new template candidate is registered in the template memory 14a (S100). The new template candidate registered here can be used in creating the new template candidate as the registered template T (sample data) in the new user registration process from the next time.

The manager is inquired about whether or not the grouping process is performed (S102). When the grouping process is not performed (S102: No), the main process is directly ended. In contrast, when the grouping process is performed (S102: Yes), the grouping process (S104) is performed and the main process is ended.

With the new user registration process, the new template candidate can be created based on the registered template T (sample data). Accordingly, the working load of the manager can be relieved.

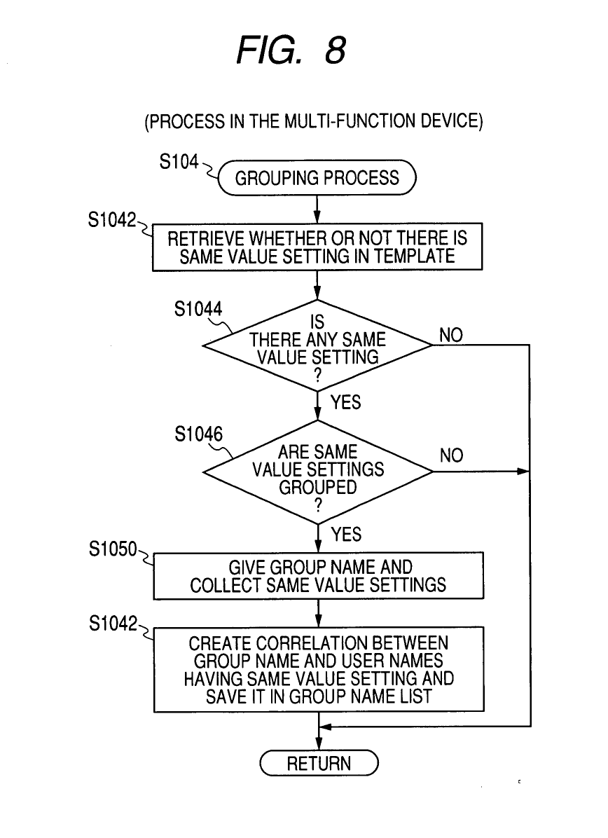

Referring to FIG. 8, the grouping process (S104) will be described below. FIG. 8 is a flowchart showing the grouping process (S104).

At first, it is retrieved whether or not there are templates T with the same settings (i.e., all the settings are the same) among the templates T stored in the template memory 14a (S1042). When there are not templates with the same settings (S1044: No), the grouping process is ended.

In contrast, when there are the templates T with the same settings (S1044: Yes), it is inquired whether or not the users with the same settings are grouped (S1046). When the manager selects not grouping the users with the same settings (S1046: No), the grouping process is directly ended.

When the manager selects grouping the users with the same settings (S1046: Yes), the users are grouped and given the group name to integrate the templates T with the same settings (only one is left and the remaining is removed) (S1048). Next, the correlation between the group name and the user names (personal names of the group member) having the same settings is created, and saved in the group name memory 14c (see FIG. 3C), and the grouping process is ended.

According to the grouping process, the templates T with the same settings are integrated, whereby the use area of the template memory 14a can be saved. Further, when one template T is changed, the changes for the users with the group can be made collectively. Accordingly, the setting operation of the manager can be relieved.

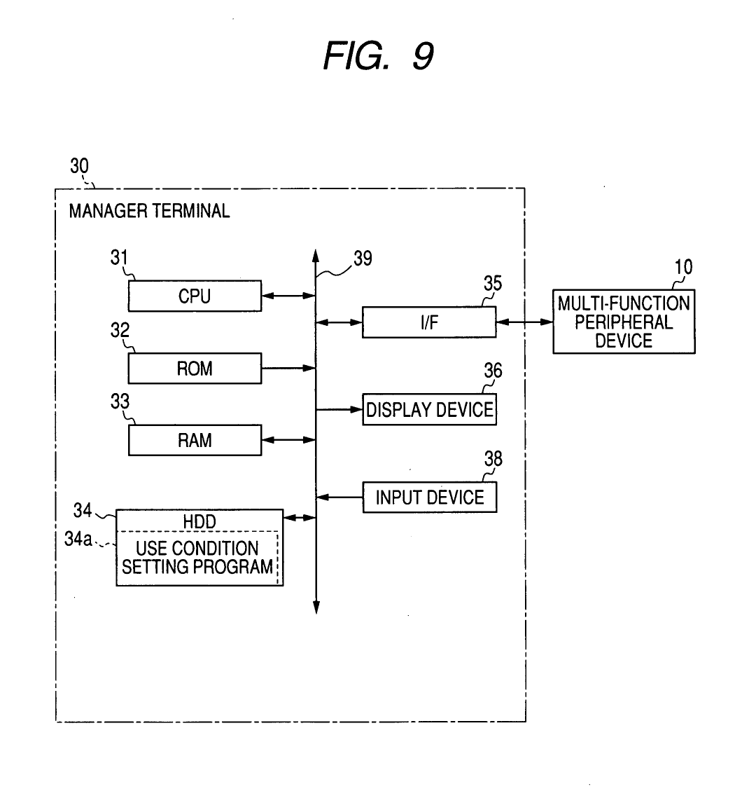

Referring to FIG. 9, a second aspect of the invention will be described below. FIG. 9 is an exemplary block diagram showing a personal computer for manager 30 (hereinafter a manager terminal 30) in which a use condition setting program is installed and a multi-function device 10 connected to the manager terminal 30 according to the second aspect of the invention. In the second aspect, the same or like parts are designated by the same signs as in the first aspect, and the description of those same parts is omitted.

The manager terminal 30 includes a CPU 31, a ROM 32, a RAM 33, a hard disk drive 34 (HDD 34), an interface 35 (I/F 35) for connection to the multi-function device 10, a display device 36, and an input device 38.

The CPU 31, the ROM 32, the RAM 33, the HDD 34, the I/F 35, the display device 36 and the input device 38 are connected via a bus 39. The I/F 35 is connected to an interface of the multi-function device 10 using a USB cable or LAN cable, for example. The manager terminal 30 sends the setting inputted from the input device 38 via the I/F 35 and the interface of the multi-function device 10. Accordingly, the setting can be reflected to any template T stored in the template memory 14a of the multi-function device 10.

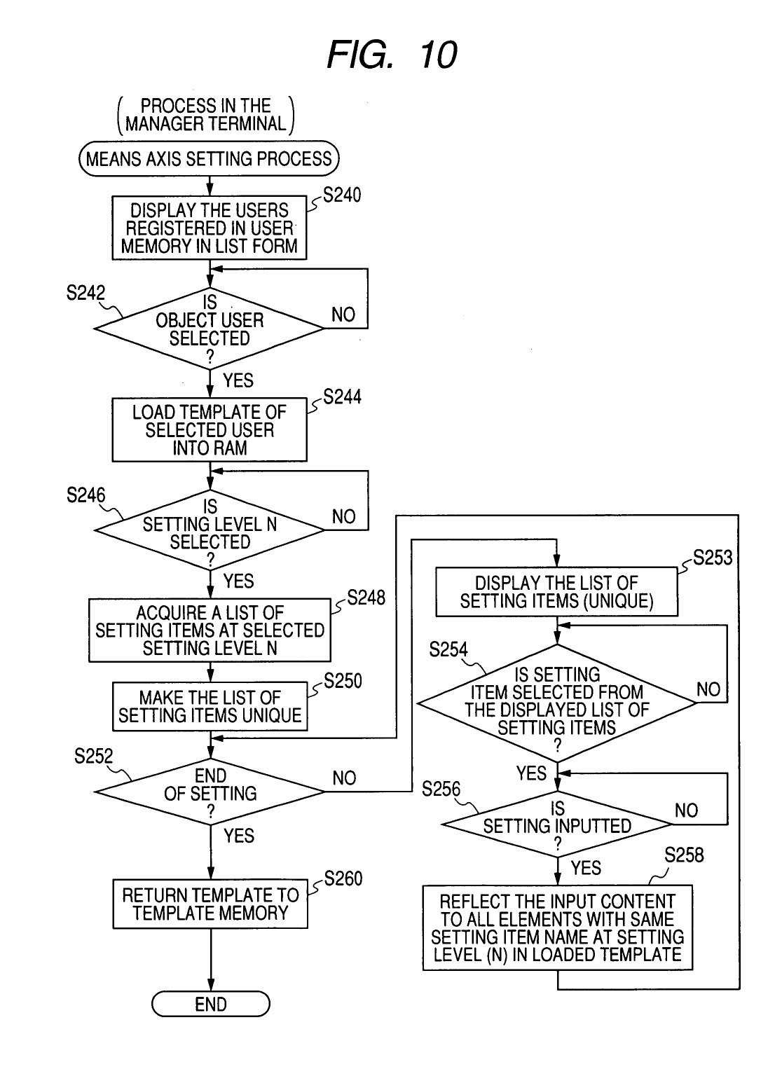

The CPU 31 is a central processing unit that has control over the manager terminal 30 and executes various kinds of program such as a program for performing a process as shown in a flowchart of FIG. 10.

The ROM 32 is a non-volatile memory for storing various kinds of control program executed by the CPU 31 and the fixed value data. The RAM 33 temporarily stores the data or program required for various kinds of process performed by the CPU 31.

The HDD 34 is a rewritable non-volatile memory. A use condition setting program 34a for performing the process as shown in the flowchart of FIG. 10 is stored in the HDD 34.

The input device 38 is composed of a keyboard and a mouse for inputting the data or a command into the manager terminal 30. In the second aspect, the manager inputs the setting for the use condition of the function in the multi-function device 10 from this input device 38.

Referring to FIG. 10, the process for reflecting the setting inputted from the input device 38 of the manager terminal 30 to the template T in the template memory 14a (see FIG. 1) of the multi-function device 10 will be described below.

FIG. 10 is a flowchart showing a means axis setting process performed in the manager terminal 30. The means axis setting process performed in the manager terminal 30, like the means axis setting process (see FIG. 6) performed in the multi-function device 10, is performed when the template T already registered in the template memory 14a is changed. For example, the means axis setting process is performed when the manager makes a change request for the template T from the input device 38.

At first, the users registered in the user memory (see FIG. 1) are read from the multi-function device 10, and the read users are displayed in list form on the display device 36 (see FIG. 9) of the manager terminal 30 (S240), as shown in FIG. 10. And the operation waits until an object user is selected from among the users displayed in list form by the manager (S242). When the manager selects the object user by performing the input operation from the input device 38 (S242: Yes), the template T associated with the selected user is read from the template memory 14a (see FIG. 1) of the multi-function device 10, and loaded into the RAM 33 (S244).

Next, the operation waits until the setting level (N) is selected (S246). And if the setting level (N) is selected based on an input from the input device 38 by the manager (S246: Yes), a list of setting items at the selected setting level (N) is acquired (S248). For example, if the setting level (3) is selected, the “color”, “monochrome”, “color”, “monochrome”, . . . are acquired as the list of setting items at the setting level (3) (see FIG. 2).

Next, the acquired list of setting items is made unique to acquire the list of setting items (unique) (S250).

Next, it is judged whether or not the setting end is selected by the manager (S252). If the setting end is not selected (S252: No), the list of setting items (unique) is displayed on the display device 36 (S253). And the operation waits until any setting item is selected from the displayed list of setting items (unique) (S254). For example, if the setting level 3 is firstly selected by the manager, “color” and “monochrome” are displayed as the unique list of setting items at the setting level 3, whereby the operation waits until any setting item is selected.

Next, if any setting item is selected based on an input of the input device 38 by the manager (S254: Yes), the operation waits until the setting is inputted for the setting item (S256).

And if the setting is inputted from the input device 38 by the manager (S256; Yes), the inputted setting is reflected to the template T loaded into the RAM 33. Herein, the inputted setting is reflected to all the setting items with the same name at the selected setting level (N).

If the setting end is selected by the manager (S252: Yes) while the process is repeated in this manner, the template loaded into the RAM 33 is returned to the template memory 14a of the multi-function device 10 and the process is ended (S260).

With the means axis setting process as shown in FIG. 10, the manager can perform the change operation of the template T from the manager terminal 30. Also, the setting inputted from the input device 38 of the manager terminal 30 is reflected to the settings for all the functions having the subject item with the same name. That is, one setting inputted from the input device 38 by the manager is reflected to the settings regarding the use conditions for plural functions. Accordingly, the working load of the manager can be relieved as compared with the case where the setting is inputted for each function.

The manager terminal 30 of the second aspect performs the processes corresponding to the function axis setting process (see FIG. 5) and the new user registration process (see FIG. 7) as described in the first aspect in accordance with the use condition setting program 34a, although the processes are not particularly described here.

While the invention has been described above based on the above aspects, aspects of the invention is not limited. Various improvements or modifications may be made thereto.

For example, the template memory 14a of the first is aspect includes the setting items up to the setting level (3), but the maximum value of the setting level (N) is arbitrary.

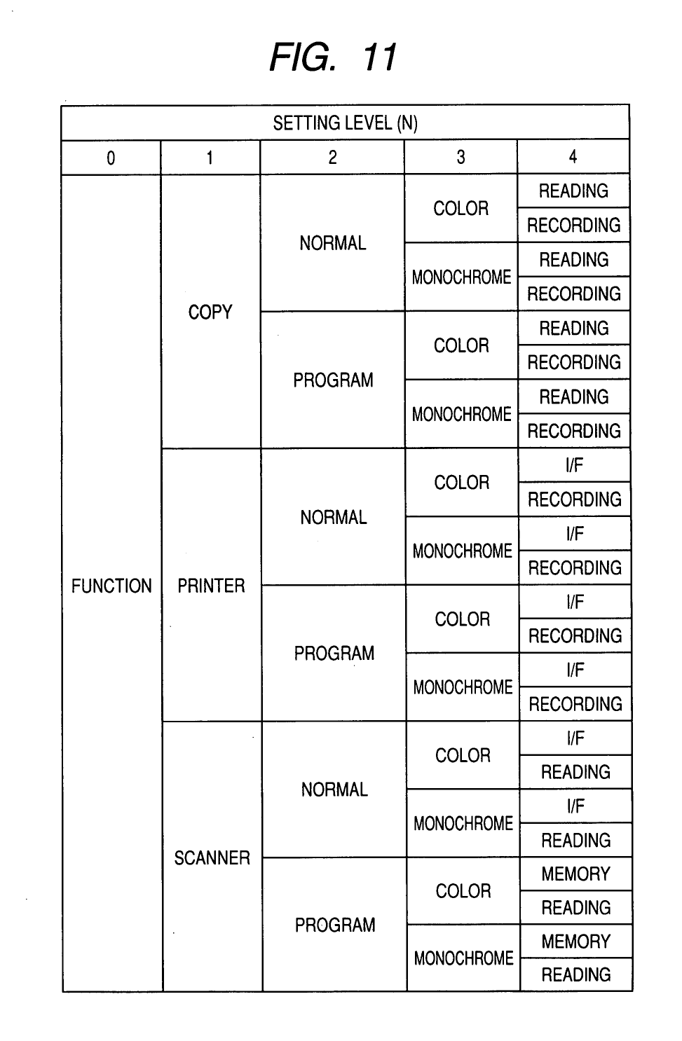

FIG. 11 is a view showing a first variation example of the setting items provided in the multi-function device 10, corresponding to FIG. 2. The minuter settings can be made by providing up to the setting level (4), as shown in FIG. 11. For example, “color” and “monochrome” of the subject items of the setting item “copy” further include the subject items “reading” and “recording” as in the example as shown in FIG. 11. In this manner, the minuter settings can be made such that the “reading” of “color” is permitted for the operation of the scanner 19 and the “recording” (i.e., printing) of “color” is prohibited for the operation of the printer 18.

Also, “color” and “monochrome” of the subject items of the setting item “printer” further include the subject items “I/F” and “recording.” In this manner, the minuter settings can be made such that the input/output of the “color” image data is permitted for the I/F operation with the parallel I/F 22, and the “recording” of “color” is prohibited for the operation of the printer 18.

Also, “color” and “monochrome” of the subject items for “normal” of the setting item “scanner” further include the subject items “I/F” and “reading.” In this manner, for example, the minuter settings can be made such that outputting the image data of “color” to the PC is prohibited for the I/F operation with the parallel. I/F 22, while the “reading” of “color” is permitted for the operation of the scanner 19.

Also, “color” and “monochrome” of the subject items for “program” of the setting item “scanner” further include the subject items “memory” and “reading.” In this manner, the minuter settings can be made such that to write the image data of “color” into the memory card is prohibited for the operation of the slot part 21, while the reading of “color” is permitted for the operation of the scanner 19.

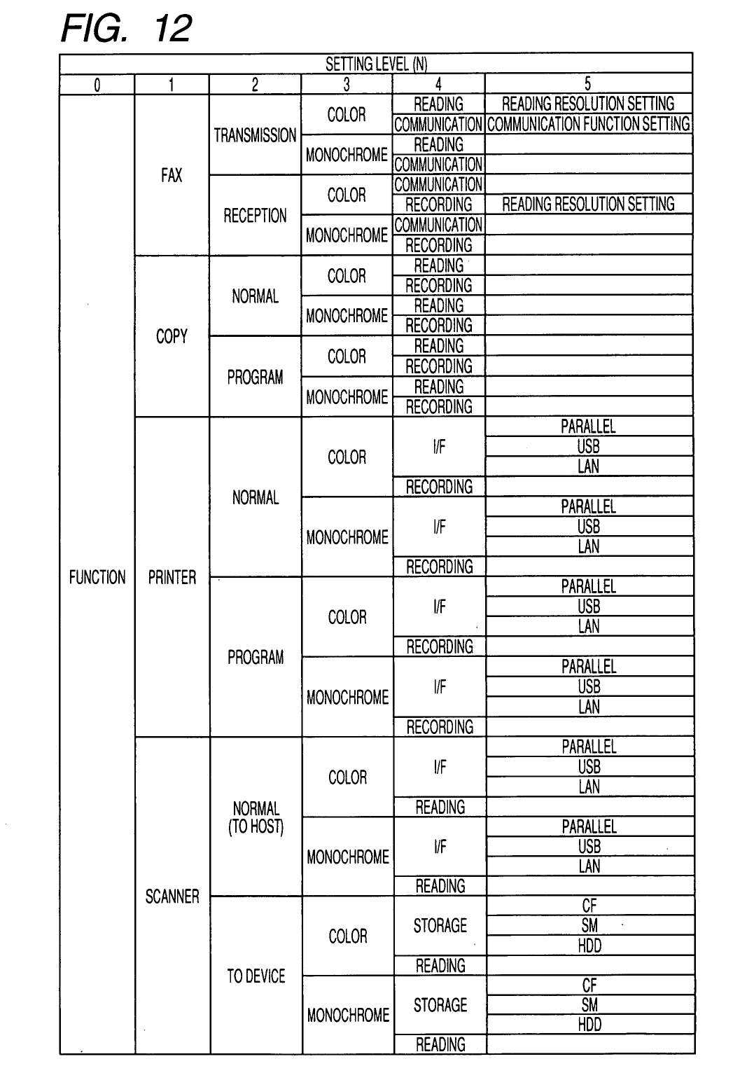

FIG. 12 is a view showing a second variation example of the setting items provided in the multi-function device 10, corresponding to FIG. 2. Though only the setting items of “copy”, “printer” and “scanner” are provided in the template memory 14a of the first aspect as described above, the setting item for other function such as “facsimile” may be provided as shown in FIG. 12. In this case, the facsimile function, the printer function, the scanner function and the copy function correspond to either the first function or the second function in the claims.

For example, the “transmission” and “reception” may be provided as the subject items of the setting item “facsimile.” Accordingly, “transmission” is only prohibited but “reception” is permitted in the facsimile function can be made.

Though either the “use permission” or “use prohibition” is set for each setting item in the first aspect, various parameters for deciding the use condition such as resolution and communication function may be set. Accordingly, more flexible settings can be made.

For example, the “reading resolution setting” and “recording resolution setting” are provided at the lowest level of the setting item “facsimile”, as shown in FIG. 12. In this manner, the reading resolution of the scanner 19 or the print resolution of the printer 18 can be set for each user. Further, the setting item “communication function setting” may be provided at the lowest level of the setting item “facsimile.” Accordingly, the communication function setting such as the communication rate, for example, can be set for each user.

The setting items “parallel”, “USB” and “LAN” may be provided in the subject item of the setting item “I/F”. Accordingly, the usable I/F among plural I/Fs provided for the multi-function device 10 can be set for each user.

The kinds of external storage devices such as the setting items “CF (compact flash®)”, “SM (smart media®)” and “HDD (hard disk drive)” may be provided at the lowest level of the function “scanner.” Accordingly, the kind of usable external storage device can be set.

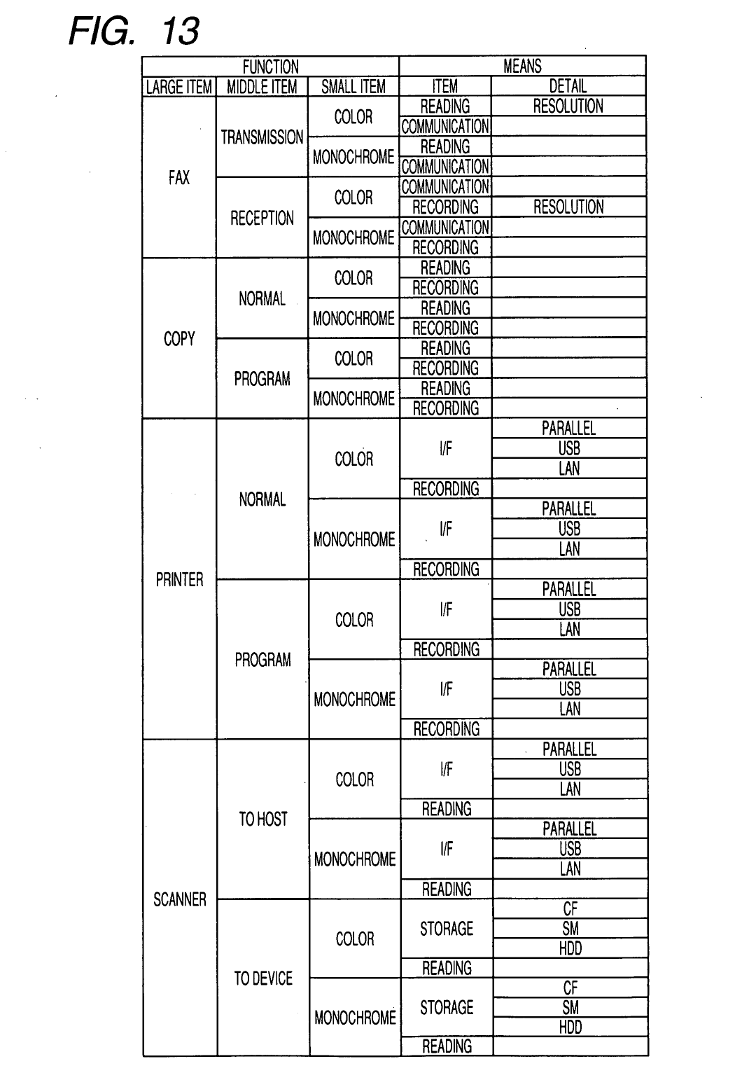

FIG. 13 is a view showing a third variation example of the setting items provided in the multi-function device 10, corresponding to FIG. 2. In the template memory 14a of the first aspect as described above, the setting items are classified for each setting level (N). However, the setting items may not be necessarily classified for each setting level (N). For example, the setting items may be divided into the “function” and “means”, the “function” may be further classified into the “large item”, “middle item” and “small item”, and the “means” may be further classified into the “item” and “detail”, as shown in FIG. 13. In this manner, it is required that the classification of the setting items is easily recognized sensibly by the manager, but the setting items may not be necessarily classified at the setting level (N).

In the function axis setting process (see FIG. 5) and the means axis setting process (see FIGS. 6 and 10) of the aspects, when the template T is changed, the user is selected and one template T corresponding to the user is changed. However, a plurality of templates T may be changed at the same time. For example, when the manager selects a plurality of users as the objects of setting change, the manager may select one template T from among the plurality of templates T corresponding to the plurality of users. And the selected template T may be changed arbitrarily, and the template T after change may be associated with all the users selected at first. In this manner, the setting can be changed collectively for the plurality of users, and the setting operation can be further facilitated.

Also, when the manager selects all the users as the objects of setting change, the template T at any location may be changed arbitrarily, and the template T after change may be associated with all the users. In this manner, the setting can be changed collectively for all the users, and the setting operation can be further facilitated.

Though in the above aspects, the user name and the template T are stored in different areas of the EEPROM 14, the user name and the template T may not be stored in different areas but may be directly associated and stored in the EEPROM 14. Or they may be stored in the template memory 14a. Also, at the processing of S82 in the new user registration process (see FIG. 7), the usable template T and the user name with the template may be associated and displayed.

According to aspects of the present invention, the working load of the manager can be less than the input by the input means required for the setting for each of the first function and the second function.

The multi-function device may perform at least two functions, including a copy function of printing the original image read by a reading unit, a printer function of printing the data inputted by an external apparatus such as a personal computer, a scanner function of storing the original image read by reading means in an external apparatus connected via connection means, and a facsimile function of sending the original image read by reading means via a communication line or printing the data received via the communication line.

Further, according to aspects of the present invention, the working load of the manager can be relieved by easily creating the use condition data.

For example, if the sample data of information protection type in which the use of the function for making the communication with the other apparatus such as the facsimile function is prohibited but the use of other functions is permitted, or the sample data of print resource protection type in which the color print is prohibited, is stored beforehand in the memory, the setting predicted to be frequently used can be easily made from the viewpoint of providing adequate security or suppressing the running cost.

Still further, according to aspects of the present invention, the working load of the manager can be relieved by easily creating the use condition data. That is, since the use condition data of one user already stored in the memory accords with the characteristic of a group that employs the multi-function device, it is predicted that the same or similar setting are frequently used from now on. Accordingly, the working load of the manager can be relieved by creating the use condition data based on the setting.

Still further, according to aspects of the present invention, the working load of the manager can be relieved because the setting regarding the use condition can be managed on a group basis.

Still further, according to aspects of the present invention, the input made by the manager using the input unit is reflected to the setting regarding the use condition for each of the first function and the second function. Accordingly, the working load of the manager can be smaller than the input by the input unit required for the setting of each of the first function and the second function.

What is claimed is:

1. A multi-function device capable of performing at least a first function and a second function, the multi-function device comprising:
a function performing unit that operates to perform the first function and the second function;
a memory that stores use condition data including a setting of use condition for each of the first function and the second function for each user;
an input unit that inputs a setting of the use condition for the operation of the function performing unit for each user; and
a controller that is operable to reflect the setting of the use condition inputted by the input unit to the setting of the use condition for each of the first function and the second function included in the use condition data.

2. The multi-function device according to claim 1,
wherein the first function includes at least one of a copy function, a printer function, a scanner function and a facsimile function, and
wherein the second function includes at least one of the copy function, the printer function, the scanner function and the facsimile function, the second function being different from the first function.

3. The multi-function device according to claim 1,
wherein the function performing unit includes at least one of a reading unit, a printing unit and a connection unit.

4. The multi-function device according to claim 1, wherein the controller is further operable to create the use condition data based on sample data that includes predetermined setting of the use condition for each of the first function and the second function, and store the created use condition data in the memory.

5. The multi-function device according to claim 4, wherein the controller uses the use condition data of one user previously stored in the memory as the sample data.

6. The multi-function device according to claim 1, wherein the controller is further operable to group users for whom the setting of the use condition for each of the first function and the second function are substantially identical.

7. A computer usable medium having computer readable instructions stored thereon, which, when executed by a computer for controlling a multi-function device capable of performing at least a first function and a second function, are configured to perform predetermined operations comprising:
operating a function performing unit to perform the first function and the second function;
storing in a memory use condition data including a setting of use condition for each of the first function and the second function for each user;
inputting by an input unit the setting of the use condition for the operation of the function performing unit for each user; and
reflecting the setting of the use condition inputted by the input unit to the setting of the use condition for each of the first function and the second function included in the use condition data.

8. A method for controlling a multi-function device capable of performing at least a first function and a second function, the method comprising:
operating a function performing unit to perform the first function and the second function;
storing in a memory use condition data including a setting of use condition for each of the first function and the second function for each user;
inputting by an input unit the setting of the use condition for the operation of the function performing unit for each user; and
reflecting the setting of the use condition inputted by the input unit to the setting of the use condition for each of the first function and the second function included in the use condition data.

9. The method for controlling a multi-function device according to claim 8,
wherein the first function includes at least one of a copy function, a printer function, a scanner function and a facsimile function, and
wherein the second function includes at least one of the copy function, the printer function, the scanner function and the facsimile function, the second function being different from the first function.

10. The method for controlling a multi-function device according to claim 8,
wherein the function performing unit includes at least one of a reading unit, a printing unit and a connection unit.
